(19) United States
(12) Patent Application Publication
(10) Pub. No.: US 2025/0256351 A1
(43) Pub. Date: Aug. 14, 2025

(54) DETECTION DEVICES FOR LASER SPOT WELDING MICRO-WELD SPOT QUALITY BASED ON LASER

(71) Applicant: NANJING UNIVERSITY, Nanjing (CN)

(72) Inventors: Minghui LU, Nanjing (CN); Lei DING, Nanjing (CN); Xuejun YAN, Nanjing (CN); Qiangbing LU, Nanjing (CN); Xiaodong XU, Nanjing (CN); Yanfeng CHEN, Nanjing (CN)

(73) Assignee: NANJING UNIVERSITY, Nanjing, Jiangsu (CN)

(21) Appl. No.: 19/098,964

(22) Filed: Apr. 2, 2025

Related U.S. Application Data
(63) Continuation-in-part of application No. 18/586,381, filed on Feb. 23, 2024.
Application No. 18/586,381 is a continuation of application No. PCT/CN2022/105335, filed on Jul. 13, 2022.

(30) Foreign Application Priority Data
Aug. 23, 2021 (CN) 202110971229.X

(51) Int. Cl. B23K 26/03; B23K 26/0622; B23K 26/22

(52) U.S. Cl. CPC B23K 26/032; B23K 26/0624; B23K 26/22

(57) ABSTRACT

Disclosed is a detection device for laser spot welding micro-weld spot quality based on laser ultrasound, comprising: a nanosecond pulsed laser configured to emit a laser; a half-wave plate configured to generate a phase difference of the laser; a scanning galvanometer configured to focus the laser as a point source and excite an ultrasonic wave on a surface of a sample; a multi-axis displacement platform configured to place and/or move the sample; a laser Doppler vibrometer configured to emit a probe light; an image sensor configured to acquire image data of the sample in a plurality of attitudes; an optical filter configured to receive the probe light to adjust an intensity of the probe light; and a processor configured to be in communication connection with the image sensor, the optical filter, the nanosecond pulsed laser, the scanning galvanometer, the multi-axis displacement platform, and the laser Doppler vibrometer.

### CROSS-REFERENCE TO RELATED APPLICATIONS

This application is a Continuation-in-part of U.S. patent application Ser. No. 18/586,381, filed on Feb. 23, 2024, which is a Continuation of International Application No. PCT/CN2022/105335, filed on Jul. 13, 2022, which claims priority to Chinese Patent Application No. 202110971229.X, filed on Aug. 23, 2021, the contents of each of which are hereby incorporated by reference.

### TECHNICAL FIELD

The present disclosure relates to a field of welding spot quality detection, and in particular relates to a detection device for laser spot welding micro-weld spot quality based on laser.

### BACKGROUND

Laser spot welding (LSW) is a highly efficient and precise welding process using a high energy density laser beam as a heat source, and is one of the most important aspects of laser material processing technology applications. The LSW is widely used in aerospace, automotive industry, nuclear energy, and electronics industry. Compared with traditional welding processes, the LSW has advantages of fast welding speed, high heating and cooling rate, high positioning accuracy, small heat-affected zone, and small structural deformation. As a size of the welding spot is usually on the order of hundreds of micrometers, the LSW is particularly suitable for precision welding of tiny parts. While the LSW has the above advantages, due to the large count of welding spots, the quality of each welding spot may be qualified in order to ensure the safety of devices. Otherwise, if there are defects such as false soldering, leakage of soldering, porosity, inclusions during the welding process, or fatal defects may be caused to the whole life of the welding workpiece.

Currently, two processes are mainly used for the LSW quality detection: a destructive detection and a non-destructive detection. A metallographic detection may observe a morphology of the molten pool accurately. However, the metallographic detection is destructive, the detection efficiency is low, which may not be detected online and may not meet requirements of large-scale industrial production. On the contrary, non-destructive detection technologies are widely used in the quality detection of structural components, especially an ultrasonic process. However, the ultrasonic detection requires an additional layer of coupling fluid between a transducer and a workpiece, which is a contact detection and cannot be applied to harsh environments (e.g., high temperatures, severe radiation, etc.).

Therefore, it is desired to provide a detection device for laser spot welding micro-weld spot quality based on laser ultrasound, which is capable of evaluating the quality of micro laser welding spot in a completely non-contact and non-destructive detection and estimation, and may be applied to high-temperature and extreme environments and the detection of structural members with complex morphology.

### SUMMARY

One aspect of embodiments of the present disclosure may provide a detection device for laser spot welding micro-weld spot quality based on laser ultrasound. The detection device may comprise: a nanosecond pulsed laser configured to emit a laser, wherein the laser passes through a half-wave plate and a scanning galvanometer to reach a multi-axis displacement platform; the half-wave plate configured to generate a phase difference of the laser emitted by the nanosecond pulsed laser; the scanning galvanometer configured to focus the laser as a point source and excite an ultrasonic wave on a surface of a sample according to a preset scanning path, the sample being placed on the multi-axis displacement platform; the multi-axis displacement platform configured to place and/or move the sample; wherein the multi-axis displacement includes at least a translation axis and a rotation axis to provide the sample with at least two degrees of freedom (DOF) of independent translation and independent rotation; a laser Doppler vibrometer configured to emit a probe light for detecting the ultrasonic wave; an image sensor configured to acquire a plurality pieces of image data of the sample in a plurality of attitudes in response to determining that the multi-axis displacement platform translates the sample based on the translation axis or rotates the sample based on the rotation axis, the plurality pieces of image data being used to determine a surface feature of the sample; an optical filter configured to receive the probe light emitted by laser Doppler vibrometer to adjust an intensity of the probe light, the laser passing through the optical filter to reach the multi-axis displacement platform; wherein a preset angle of the optical filter is set based on a sample feature, and the sample feature includes the surface feature obtained based on the plurality pieces of image data; and a processor configured to be in communication connection with the image sensor, the optical filter, the nanosecond pulsed laser, the scanning galvanometer, the multi-axis displacement platform, and the laser Doppler vibrometer.

Another aspect of embodiments of the present disclosure may provide a detection method for laser spot welding micro-weld spot quality based on laser ultrasound, implemented by a processor, comprising: performing a one-dimensional linear shape scanning, a two-dimensional rectangular shape scanning, or a scanning based on a target scanning path under a first condition, wherein the first condition includes a laser and a probe light on an opposite side of a sample; performing the two-dimensional rectangular shape scanning or the scanning based on the target scanning path under a second condition, wherein the second condition includes the laser and the probe light on a same side of the sample; controlling a scanning path of a scanning galvanometer by the processor, recording positions of a plurality of excitation points and a position of a detection spot, visualizing an acoustic field of an ultrasonic wave, and obtaining a visualization processing result; determining an energy density spectrum of transmission; and determining welding quality of laser spot welding based on the visualization processing result.

### BRIEF DESCRIPTION OF FIGURES

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an exemplary structure of a detection device for laser spot welding micro-weld spot quality based on laser ultrasound according to some embodiments of the present disclosure;

FIG. 2 is a schematic diagram illustrating a cross-sectional view of a sample according to some embodiments of the present disclosure;

FIG. 3 is a schematic diagram illustrating a one-dimensional linear shape scanning according to some embodiments of the present disclosure;

FIG. 4 is a schematic diagram illustrating a two-dimensional rectangular shape scanning according to some embodiments of the present disclosure;

FIG. 5 is a flowchart illustrating an exemplary detection process of a detection device for laser spot welding micro-weld spot quality based on laser ultrasound according to some embodiments of the present disclosure;

FIG. 6 is a schematic diagram illustrating an exemplary Lamb wave according to some embodiments of the present disclosure;

FIG. 7 is a schematic diagram illustrating an exemplary visualization ultrasonic field map according to some embodiments of the present disclosure, wherein (a) and (b) are schematic diagrams illustrating 1.2 mm standard welding at different moments, and (c) and (d) are schematic diagrams illustrating a 0.4 mm standard welding and a 0.4 mm false welding at the same moment;

FIG. 8 is a schematic diagram illustrating an exemplary industrial computed tomography (CT) testing result according to some embodiments of the present disclosure; wherein (a) is a schematic diagram illustrating a top view of a 1.2 mm standard welding diagram, (b) is a schematic diagram illustrating a cross-sectional view of a 1.2 mm standard welding diagram, (c) is a schematic diagram illustrating a top view of a 1.2 mm false welding diagram, and (d) is a schematic diagram illustrating a cross-sectional view of a 1.2 mm false welding diagram.

### DETAILED DESCRIPTION

In order to more clearly illustrate the technical solutions of the embodiments of the present disclosure, the accompanying drawings, which are required to be used in the description of the embodiments, are briefly described below. The accompanying drawings do not represent the entirety of the embodiments.

It should be understood that the terms “system,” “device” as used herein, “unit” and/or “module” as used herein is a way to distinguish between different components, elements, parts, sections or assemblies at different levels. The words may be replaced by other expressions if other words accomplish the same purpose.

As shown in the present disclosure and in the claims, unless the context clearly suggests an exception, the words “a,” “an,” and/or “the” do not refer specifically to the singular, but may also include the plural. Generally, the terms “including” and “comprising” suggest only the inclusion of clearly identified steps and elements. In general, the terms “including” and “comprising” only suggest the inclusion of explicitly identified steps and elements that do not constitute an exclusive list, and the method or apparatus may also include other steps or elements.

When describing the operations performed in the embodiments of the present disclosure in step-by-step fashion, the order of the steps is all interchangeable if not otherwise indicated, the steps are omissible, and other steps may be included in the operation.

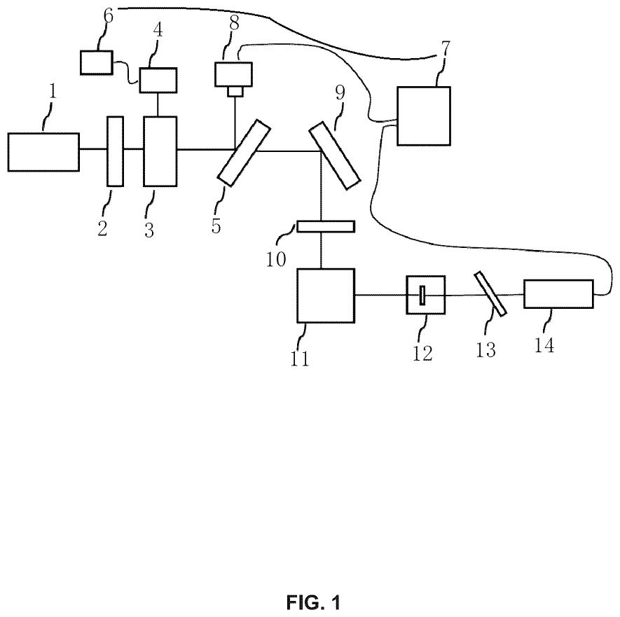

FIG. 1 is a schematic diagram of the structure of a detection device for laser spot welding micro-weld spot quality based on laser ultrasound according to some embodiments of the present disclosure.

In some embodiments, a detection device for laser spot welding micro-weld spot quality based on laser ultrasound may comprise: a nanosecond pulsed laser 1 configured to emit a laser, wherein the laser emitted by the nanosecond pulsed laser 1 may pass through a half-wave plate 2 to reach a polarizing beam splitter 3; the polarizing beam splitter 3 configured to perform a laser beam splitting, wherein a laser beam after performing the laser beam splitting by the polarizing beam splitter 3 may enter an energy detector 4 and a beam splitter mirror 5, respectively; the beam splitter mirror 5 configured to perform the laser beam splitting on the laser entering the beam splitter mirror, wherein the laser beam after performing the laser beam splitting may enter a photodetector 8 and a light reflecting mirror 9, respectively; an aperture 10 configured for the laser beam passing through the light reflecting mirror 9, the laser beam passing through a scanning galvanometer 11 to reach a multi-axis displacement platform 12; the multi-axis displacement platform 12 configured to place and/or move a sample.

In some embodiments, the nanosecond pulsed laser 1 may be configured to emit the laser. In some embodiments, a wavelength range and a pulse width range of the nanosecond pulsed laser may be preset. For example, the wavelength range may include 532-1064 nm and the pulse width range may include 6-12 ns. For example, the wavelength may be 1064 nm and the pulse width may be 8 ns.

In some embodiments, the laser emitted from the nanosecond pulsed laser 1 may pass through the half-wave plate 2 to reach the polarizing beam splitter 3.

The half-wave plate 2 may be used to generate a phase difference equal to x or an odd multiple of x between an ordinary light and an extraordinary light of the incoming laser. The ordinary light refers to a refracted light that follows laws of refraction. The extraordinary light refers to a refracted light that does not follow laws of refraction.

The polarizing beam splitter 3 may be configured to perform the laser beam splitting. In some embodiments, the laser beam after performing the laser beam splitting by the polarizing beam splitter 3 may enter the photodetector 4 and the light reflecting mirror 5, respectively.

The energy detector 4 may be configured to detect a beam energy of the laser. A head 6 of energy detector may be configured to display a numerical value of the beam energy of the laser detected by the energy detector 4. In some embodiments, the energy detector 4 may be connected with the processor 7 via the head 6 of the energy detector according to a preset process. The preset connection process may include a cable connection, a wireless connection, or the like.

The beam splitter mirror 5 may be configured to perform the laser beam splitting on the laser entering the beam splitter mirror. In some embodiments, the laser beam after performing the laser beam splitting by the beam splitter mirror 5 may enter the photodetector 8 and the light reflecting mirror 9, respectively.

The light reflecting mirror 9 may be configured to change a direction of the laser beam. In some embodiments, the laser beam reflected by the light reflecting mirror 9 may pass through the aperture 10 and enter the scanning galvanometer 11.

The photodetector 8 may be configured to convert an optical signal into an electrical signal. In some embodiments, the photodetector 8 may be connected with the processor 7 according to a preset connection process.

The aperture 10 may be configured for the laser beam passing through the light reflecting mirror, the laser beam may pass through a scanning galvanometer to reach a multi-axis displacement platform.

The scanning galvanometer 11 is configured to focus the laser beam as a point source and excite an ultrasonic wave on a surface of the sample according to a preset scanning path. In some embodiments, a maximum resonant frequency of the scanning galvanometer may be 10 KHz.

In some embodiments, the scanning galvanometer 11 may be connected with the processor 7 according to a preset connection process. More descriptions of the preset connection process may be found in the above descriptions of the present disclosure.

In some embodiments, the scanning galvanometer 11 may excite the ultrasonic wave on the surface of the sample based on a scanning parameter. The scanning parameter may include a scanning position and a preset scanning path.

The sample refers to a welding member for testing the detection device for laser spot welding micro-weld spot quality based on laser ultrasound. In some embodiments, the sample may be composed by a variety of forms, for example, the sample may include two pieces of sheet metal welded together. In some embodiments, material of the sample may include stainless steel, aluminum alloy, or the like.

In some embodiments, a plurality of samples with different welding spot characteristics may be used when testing the detection device for laser spot welding micro-weld spot quality based on laser ultrasound. The welding spot characteristics may characterize process parameters of the welding spots on the sample. In some embodiments, the welding spot characteristics may include quality of the welding, a diameter of the welding spot, such as a standard welding or false welding with welding spot characteristics that a diameter is 1.2 mm. The standard welding refers to welding having acceptable quality. The false welding refers to welding with unqualified quality.

The preset scanning path refers to a preset path along which the scanning galvanometer excites the ultrasonic wave on the surface of the sample. In some embodiments, the preset scanning path may include a one-dimensional linear shape scanning and a two-dimensional rectangular shape scanning.

In some embodiments, when the preset scanning path is the one-dimensional linear shape scanning, the laser beam and the probe light are on an opposite side of the sample. The probe light is emitted by a laser Doppler vibrometer.

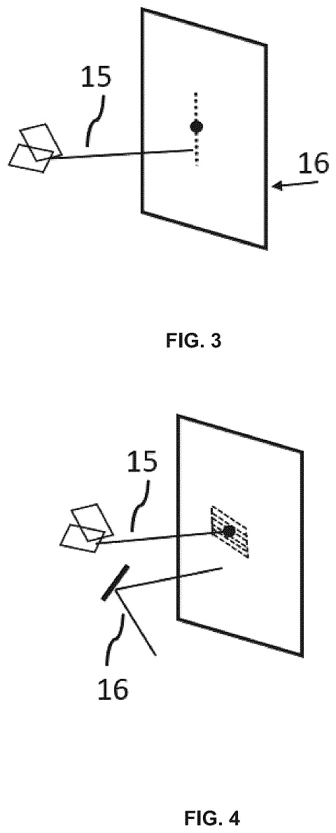

In some embodiments, as shown in FIG. 3, when the preset scanning path is the one-dimensional linear shape scanning and laser beam 15 and a probe light 16 are on the opposite side of the sample, the laser beam 15 and the probe light 16 are located in the same perpendicular direction, the probe light 16 is located below the laser beam 15, and a center of a scanning path of the laser beam 15 is a position of a welding spot. The position of the welding spot is an actual position where the welding spot is located on a side of the sample facing the laser beam.

The center of the scanning path refers to a position of a center point of the preset scanning path. In some embodiments, when the preset scanning path is the one-dimensional linear shape scanning, the center of scanning path is a midpoint of the linear shape.

In some embodiments, the preset scanning path is the two-dimensional rectangular shape scanning, the laser beam and the probe light are on an opposite or same side of the sample.

In some embodiments, when the preset scanning path is the two-dimensional rectangular shape scanning and the laser beam and the probe light are on the opposite side of the sample, the position of the probe light is a backside position of a welding spot, and the center of the scanning path of the laser beam is a position of the welding spot. A backside position of the welding spot is an actual position of the welding spot on a side of the sample that faces the probe light.

In some embodiments, as shown in FIG. 4, when the welding spot path is the two-dimensional rectangular shape scanning and the laser beam 15 and the probe light 16 are on the same side of the sample, the probe light 16 is located directly below the preset scanning path, and the center of the scanning path of the laser beam 15 is the position of the welding spot.

In some embodiments, when the preset scanning path is the two-dimensional rectangular shape scanning, the center of the scanning path is a geometric center of the rectangular shape.

The multi-axis displacement platform 12 may be configured to place and/or move the sample. In some embodiments, the multi-axis displacement platform 12, an optical filter 13, and a laser Doppler vibrometer 14 are deployed in a same line.

In some embodiments, the multi-axis displacement platform 12 may include a translation axis, a rotation axis, etc., to provide the sample with at least two degrees of freedom (DOF) of independent translation and independent rotation. It is understood that the shape of some samples is irregular, and the sample can be positioned with a plurality of DOFs through the translation axis and the rotation axis to improve the comprehensiveness of the scanning galvanometer 11.

The laser Doppler vibrometer 14 may be configured to measure sample vibrations by emitting the probe light to a surface of the sample. In some embodiments, the laser Doppler vibrometer 14 may be connected with the processor. In some embodiments, an operating wavelength of the laser Doppler vibrometer may be preset, such as 633 nm.

In some embodiments, the probe light emitted from the laser Doppler vibrometer 14 may pass through the optical filter 13 to the surface of the sample.

In some embodiments, the laser Doppler vibrometer 14 may be connected with the processor according to a preset connection process.

The optical filter 13 may be configured to reduce an intensity and reflection of light. In some embodiments, the optical filter 13 may be placed directly in front of the laser Doppler vibrometer at a variety of preset angles. The preset angle may be preset, such as 45°.

The processor 7 may process data and/or information obtained and/or extracted from the energy detector 4, the photodetector 8, the scanning galvanometer 11, the laser Doppler vibrometer 14, and/or other storage devices. For example, the processor may obtain a numerical value of the beam energy of the laser detected by the energy detector. As another example, the processor may obtain an electrical signal from the photodetector. As a further example, the processor may record a position of each excitation point based on a preset scanning path and a position of the detection spot.

In some embodiments, the processor 7 may be a single server or a group of servers. The server group may be centralized or distributed. In some embodiments, the processor 7 may be local or remote. In some embodiments, the processor 7 may be implemented on a cloud platform. For example, a cloud platform may include a private cloud, a public cloud, a hybrid cloud, a community cloud, a distributed cloud, an on-premises cloud, a multi-tier cloud, or any combination thereof. In some embodiments, the processor 7 may be integrated on an end device. The end device may include a cell phone, a laptop, a desktop computer, or the like.

The image sensor (not shown in the figure) may be configured to collect a plurality pieces of image data of the sample in a plurality of attitudes when the multi-axis displacement platform translates the sample based on the translation axis or rotates the sample based on the rotation axis. The plurality pieces of image data may be at least used to determine a surface feature of the sample.

In some embodiments, the image sensor may include a CCD device, a CMOS sensor, an infrared thermal imager, etc. The image sensor may be in communication connection with the processor 7.

The image data refers to an image related to the sample. In some embodiments, the image data may include an optical image, etc. The image sensor may collect optical images of the sample in the plurality of attitudes as the plurality pieces of image data, and send the plurality pieces of image data to the processor.

The plurality attitudes refer to a plurality of angles of the sample after the sample is translated and/or rotated through the multi-axis displacement platform.

In some embodiments, the plurality of attitudes may be preset based on historical experience. Each of the plurality of attitudes may include at least one of a position of the translation axis and a position of the rotation axis.

In some embodiments, the processor 7 may determine a count of the plurality of attitudes based on a shape feature of the sample. For example, the processor 7 may construct a vector to be matched based on the shape feature of the sample, and construct a standard vector based on a standard shape feature, and determine the count of the plurality of attitudes based on a difference between the vector to be matched and the standard vector. The greater the difference between the vector to be matched and the standard vector, the more the count of the plurality of attitudes is determined. The vector to be matched may be a feature vector constructed based on the shape feature of the sample. The standard vector may be a feature vector constructed based on the standard shape feature.

The shape feature refers to data that characterizes a contour of the sample. In some embodiments, the shape feature may include laser point cloud data that characterizes the contour of the sample. The shape feature may be obtained by pre-scanning the sample before welding using the detection device for laser spot welding micro-weld spot quality based on laser ultrasound.

The standard shape feature refers to a shape feature of a standard sample. The standard sample refers to an ideal sample that satisfies welding requirements.

In some embodiments, the difference between the vector to be matched and the standard vector may be represented by a similarity between vectors. The lower the similarity, the greater the difference. The similarity between the vectors may be represented by a distance between the vectors. The distance between the vectors may include a Euclidean distance, or the like.

In some embodiments, the plurality pieces of image data may be used to determine the surface feature of the sample, etc. For example, the processor 7 may determine the surface feature of the sample by a feature extraction model based on the plurality pieces of image data.

The surface feature refers to data related to a surface condition of the sample. In some embodiments, the surface features may include at least one of a surface shape, texture, size, or the like, of the sample. The surface of the sample may include a surface where a welding spot exists on the sample.

In some embodiments, the feature extraction model may be a machine learning model. For example, the feature extraction model may include any one of a convolutional neural network (CNN) model, a neural network (NN) model, or other custom model structures, or any combination thereof.

In some embodiments, the processor 7 may train the feature extraction model based on a large number of first training samples with first labels by gradient descent, etc. The first training samples may include sampling image data of a plurality of sampling samples, and the first labels of the first training samples may include actual surface features of the sampling samples.

In some embodiments, the first training sample may be obtained based on historical data, and the first labels may be determined based on manual annotation. For example, the processor 7 may use a plurality pieces of image data of the sample in historical data as a plurality pieces of sampling image data. As another example, those skilled in the art may measure and annotate the shape, texture, and size of the surface of the sample in the historical data.

In some embodiments, the feature extraction model may be trained by: inputting the plurality of first training samples with the first labels into an initial feature extraction model, constructing a loss function based on the first labels and prediction results of the initial feature extraction model, updating the initial feature extraction model based on iterations of the loss function, and completing the training of the feature extraction model when the loss function of the initial feature extraction model satisfies a preset condition. The preset conditions may be that the loss function converges, a count of the iterations reaches a set value, etc.

In some embodiments, the processor 7 may set a preset angle based on a sample feature. The sample feature may include the surface feature of the sample, etc.

For example, the processor 7 may query a preset angle table for a preset angle corresponding to the surface feature based on the surface feature, and use the preset angle obtained by the query as the preset angle of the optical filter 13.

In some embodiments, the preset angle table may be preset based on experimental data, including a plurality of surface features and a preset angle corresponding to each of the plurality of surface features. An experimental process may include: for a sample corresponding to one of the surface features, scanning the sample at different angles of the optical filter, obtaining a plurality of visualization processing results, selecting a visualization processing result with a minimum noise or a signal-to-noise ratio lower than a signal-to-noise ratio threshold from the plurality of visualization processing results, and using an angle of the optical filter corresponding to the visualization processing result as the preset angle corresponding to the surface feature.

In some embodiments of the present disclosure, the preset angle of the optical filter 13 can be adjusted specifically according to the surface feature of the sample so as to obtain the visualization processing result with a higher quality.

In some embodiments, the processor 7 may determine a wavelength and a pulse width of the nanosecond pulsed laser based on the surface feature of the sample. For example, the processor 7 may query a wavelength and a pulse width corresponding to the surface feature in a first parameter table based on the surface feature, and use the wavelength and the pulse width obtained from the query as the wavelength and the pulse width of the nanosecond pulsed laser 1.

In some embodiments, the first parameter table may be preset based on experimental data, including a plurality of surface features and a wavelength and a pulse width corresponding to each of the surface features. An experimental process may include: for a sample corresponding to one of the surface features, scanning the sample at different wavelengths and pulse widths, obtaining a plurality of visualization processing results, selecting a visualization processing result with a minimum noise or a signal-to-noise ratio lower than the signal-to-noise ratio threshold among the plurality of visualization processing results, and using a wavelength and a pulse width corresponding to the visualization processing result as the wavelength and the pulse width corresponding to the surface feature. The signal-to-noise ratio threshold may be preset based on historical experience.

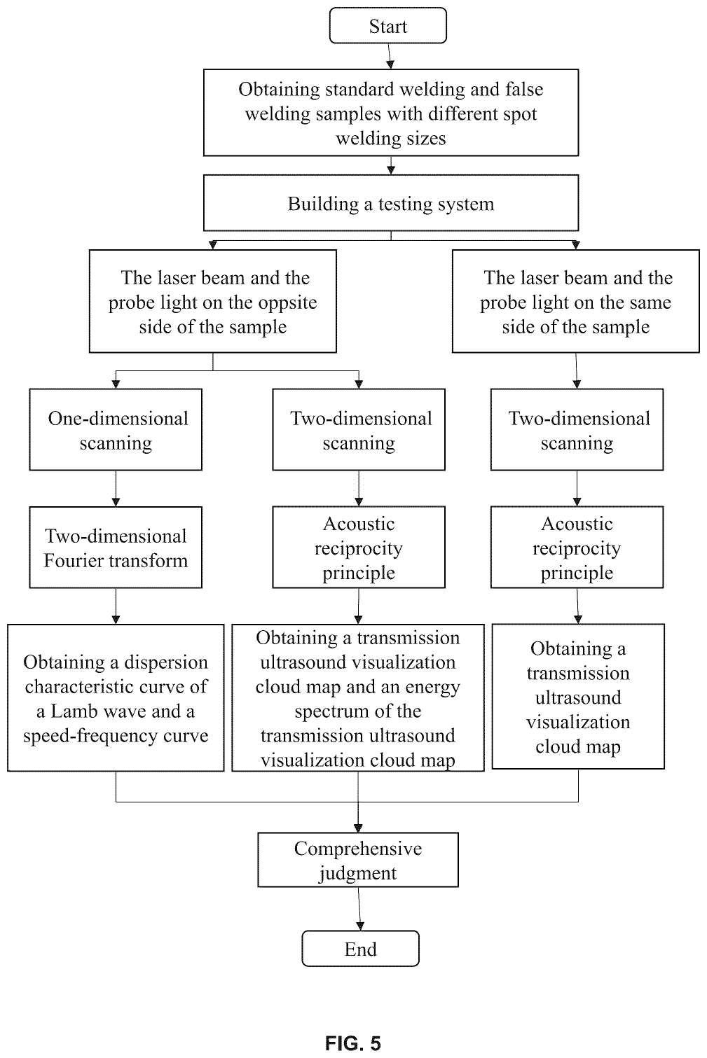

The noise of the visualization processing result may include jagging, blurring, and artifacts in the visualization processing result. More descriptions regarding the visualization processing result and obtaining the visualization processing result may be found in FIG. 5 and the related descriptions thereof.

In some embodiments, the processor 7 may send the determined wavelength and the determined pulse width to the nanosecond pulsed laser 1. The nanosecond pulsed laser 1 may adjust the wavelength and the pulse width of the nanosecond pulsed laser 1 based on the received wavelength and pulse width.

In some embodiments of the present disclosure, the wavelength and the pulse width of the nanosecond pulsed laser 1 can be specifically adjusted according to the surface feature of the sample so as to obtain the visualization processing result with a higher quality.

In some embodiments, the preset scanning path may further include a target scanning path. The processor 7 may determine a welding spot set of the sample based on the plurality pieces of image data, and determine one or more welding spots in the welding spot set as one or more first key points. The processor 7 may further determine one or more abnormal regions on the surface of the sample based on the plurality pieces of image data, determine one or more welding spots with abrupt texture changes in the one or more abnormal regions as one or more second key points, and determine the target scanning path based on the one or more first key points and the one or more second key points.

The target scanning path refers to a path along which the scanning galvanometer 11 excites the ultrasonic wave on the surface of the sample.

The welding spot set refers to a collection of data related to the welding spots. In some embodiments, the welding spot set may include a position or a size of one or more welding spots on the surface of the sample.

In some embodiments, the processor 7 may determine the position or the size of the one or more welding spots on the surface of the sample based on the plurality pieces of image data using an image recognition algorithm, etc. to obtain the welding spot set of the sample. The image recognition algorithm may include a support vector machine algorithm, an edge detection algorithm, etc.

The abnormal region refers to a region on the surface of the sample where abnormal welding spots appear. In some embodiments, the processor 7 may determine the one or more abnormal regions on the surface of the sample based on the plurality pieces of image data. For example, the processor may segment the surface of the sample into one or more regions by an image segmentation technique, and use one of the one or more regions containing the abnormal welding spots as the abnormal region, and mark the one or more abnormal regions by a preset marking process. The image segmentation technique includes Canny edge detection or threshold segmentation, etc. The preset marking process may include a morphological operation (e.g., corrosion, expansion, etc.) or Blob analysis, etc.

The abnormal welding spots refer to welding spot where welding is abnormal. In some embodiments, the abnormal welding spots may include a welding spot with an abrupt texture change, etc. The abrupt texture change may include discontinuity of fish scale patterns, uneven color, abrupt change in roughness, etc.

In some embodiments, the processor 7 may detect the welding spots with the sudden texture change using an SIFT algorithm or a SURF algorithm, and use the welding spots with the sudden texture change as the second key points.

In some embodiments, the processor 7 may generate the target scanning path based on the first key points and the second key points. For example, the processor 7 may randomly select a key point from the first key points and the second key points as a starting point of the target scanning path, generate a path covering each first key point and each second key point using a path planning algorithm, and smooth the obtained path to obtain the target scanning path. The path planning algorithm may include a greedy algorithm or a genetic algorithm. Smoothing may include polynomial interpolation, spline interpolation, etc. Smoothing the path can avoid the scanning galvanometer 11 from oscillation induced by sudden stop.

In some embodiments, the processor 7 may send the target scanning path to the scanning galvanometer 11. The scanning galvanometer 11 may excite the ultrasonic wave on the surface of sample based on the target scanning path.

In some embodiments of the present disclosure, by determining the target scanning path, the scanning galvanometer 11 can be controlled to scan the welding spots that need more attention, so as to improve the reliability of the visualization processing result, and further improve the accuracy of determining the welding quality of laser spot welding.

In some embodiments, the processor 7 may generate a plurality of candidate scanning paths. For one of the plurality of candidate scanning paths, the processor 7 may determine assessment data corresponding to the candidate scanning path based on a first coverage rate of the candidate scanning path to the one or more first key points and a second coverage rate of the candidate scanning path to the one or more second key points, and determine the target scanning path based on the assessment data corresponding to the plurality of candidate scanning paths.

The candidate scanning path refers to a target scanning path to be determined. In some embodiments, the processor 7 may randomly generate a plurality of rectangular paths with different, lengths, widths, and center coordinates, and use the plurality of rectangular paths as the candidate scanning paths.

The first coverage rate refers to data representing a coverage degree of the candidate scanning path to the first key points. The second coverage rate refers to data representing a coverage degree of the candidate scanning path to the second key points.

In some embodiments, the processor 7 may determine the first coverage rate based on a preset boundary distance, the candidate scanning paths, and positions of the first key points. For example, the processor 7 may calculate a count (denoted as a first count) of first key points whose distance from a frame of the candidate scanning path is less than a preset boundary distance, and calculate a count (denoted as a second count) of first key points whose distance from the frame of the candidate scanning path is not less than the preset boundary distance, and use a ratio of the first count to the second count as the first coverage rate. The preset boundary distance may be preset based on historical experience.

In some embodiments, the preset boundary distance may be correlated to a width or a diameter of the laser 15. The greater the width or the diameter of the laser 15, the greater the preset boundary distance.

In some embodiments, the processor 7 may determine the second coverage rate based on the preset boundary distance, the candidate scanning paths, and positions of the second key points. The process for determining the second coverage rate may be similar to the process for determining the first coverage rate.

The assessment data refers to data obtained by assessing the candidate scanning path. In some embodiments, the assessment data may be positively correlated with the first coverage rate and the second coverage rate, and negatively correlated with a total length of paths. The total length of the paths refers to a distance that the scanning galvanometer 11 moves along the candidate scanning paths. For example, the processor 7 may calculate a sum of the first coverage rate and the second coverage rate to obtain a coverage sum value, and subtract a weighted value of the total length of the paths from a weighted value of the coverage sum value to obtain the assessment data. A weight of the coverage sum value and a weight of the total length of the paths may be preset based on historical experience.

In some embodiments, the weight of the coverage sum value and the weight of the total length of the paths may be correlated with a ratio of a count of the first key points to a count of the second key points. The greater the ratio of the count of the first key points to the count of the second key points, the greater the weight of the total length of the paths. The smaller the ratio of the count of the first key points to the count of the second key points, the greater the weight of the coverage sum value.

It is understood that when the ratio of the count of the first key points to the count of the second key points is large, it means that there are more welding spots but fewer abnormal welding spots. Considering the scanning cost, the candidate scanning path with a shorter total length of the paths has greater assessment data. When the ratio of the count of the first key points to the count of the second key points is small, it means that there are fewer welding spots but more abnormal welding spots. In this case, the possibility of an internal abnormality in the sample increases, and the coverage rate of the welding spots should be improved first. The candidate scanning path with a higher coverage sum value has greater assessment data.

In some embodiments, the processor 7 may determine the target scanning path based on the assessment data corresponding to the plurality of candidate scanning paths. For example, the processor 7 may use a candidate scanning path pair with the highest assessment data as the target scanning path based on the assessment data corresponding to the plurality of candidate scanning paths.

In some embodiments of the present disclosure, if the scanning path is relatively complex, the ultrasonic wave excited by the scanning galvanometer 11 may lose a lot of information due to mutual interference or reinforcement, generating a relatively complex result. By limiting the target scanning path to a simple two-dimensional rectangular path and determining the target scanning path based on a distribution of key welding spots, it helps the scanning galvanometer 11 to excite the ultrasonic wave that is more regular and better suited to the sample.

In some embodiments, when the scanning galvanometer 11 excites the ultrasonic wave on the surface of the sample placed on the multi-axis displacement platform according to the preset scanning path, the processor may adjust the wavelength and the pulse width of the nanosecond pulsed laser 1 based on the visualization processing result obtained by real-time detection and the preset scanning path.

For example, the processor may query, based on a current position of the scanning galvanometer 11 on the preset scanning path and a signal-to-noise ratio of the visual processing results obtained by real-time detection, a wavelength and a pulse width corresponding to the position and the signal-to-noise ratio in a second parameter table, and use the wavelength and the pulse width as a current wavelength and a current pulse width of the nanosecond pulsed laser 1.

In some embodiments, the processor 7 may send the obtained wavelength and the pulse width to the nanosecond pulsed laser 1. The nanosecond pulsed laser 1 may adjust the wavelength and the pulse width of the nanosecond pulsed laser 1 based on the received wavelength and the pulse width.

In some embodiments, the second parameter table may be constructed based on experimental data, including a plurality of positions and signal-to-noise ratios and a wavelength and a pulse width corresponding to each of the plurality of positions and the signal-to-noise ratios. For example, when the position is in a high reflection region, the wavelength uses 1064 nm, etc. to optimize the signal-to-noise ratio. As another example, when the position is in a high sensitivity region, the pulse width is 20 ns, etc. to improve the time resolution. The high reflection region and the high sensitivity region can be determined in advance on the surface of the sample by those skilled in the art.

In some embodiments, when the scanning galvanometer 11 excite the ultrasonic wave on the surface of the sample placed on the multi-axis displacement platform according to the preset scanning path, the processor 7 may adjust the angle of the optical filter 13 based on the visualization processing result obtained by real-time detection. For example, the processor 7 may determine a key signal index based on the visualization processing result obtained by real-time detection, and in response to the key signal index satisfying a preset adjustment condition, determine an adjusted angle of the optical filter 13 based on the key signal index.

The key signal index refers to a parameter that reflects the signal quality of the ultrasonic wave, such as at least one of a peak amplitude, a signal-to-noise ratio, and an energy of a specific frequency, etc., of the ultrasonic wave in the visualization processing result. The specific frequency may be a frequency that needs to be focused on and is preset based on historical experience.

In some embodiments, the preset adjustment condition may include the peak amplitude being less than an amplitude threshold and/or the signal-to-noise ratio being less than a signal-to-noise ratio threshold.

In some embodiments, the processor 7 may query a preset angle table for an angle corresponding to the peak amplitude and/or the signal-to-noise ratio as the adjusted angle of the optical filter 13 based on the peak amplitude and/or the signal-to-noise ratio in the key signal index.

In some embodiments, the preset angle table may be preset based on experimental data, including a plurality of peak amplitudes and/or signal-to-noise ratios and an angle corresponding to each of the plurality of peak amplitudes and/or signal-to-noise ratios.

In some embodiments of the specification, since the angle of the optical filter directly affects a polarization direction and transmittance of an incident light, and thus affects the signal quality of an ultrasonic signal detected by the laser Doppler vibrometer, by real-time monitoring of the signal quality of the ultrasonic wave, the optical filter 13 is dynamically adjusted to the optimal angle so as to maximize the signal intensity and suppress the noise.

In some embodiments, the processor 7 may adjust an emission parameter of the laser Doppler vibrometer 14 based on the visualization processing result obtained by real-time detection. For example, the processor 7 may determine the key signal index based on the visualization processing results obtained by real-time detection, and in response to the key signal index satisfying the preset adjustment condition, determine an adjusted emission parameter based on the key signal index. The emission parameter of the laser Doppler vibrometer 14 may include at least one of an emission wavelength and an emission pulse width.

For example, in response to the peak amplitude being less than the amplitude threshold, the processor 7 may increase the emission pulse width based on a preset adjustment rule. In response to the signal-to-noise ratio being less than the signal-to-noise ratio threshold, the processor 7 may adjust the emission wavelength based on the preset adjustment rule.

In some embodiments, the preset adjustment rule may be preset based on historical experience, including an adjustment direction and an adjustment amplitude of the emission pulse width and the emission wavelength.

In some embodiments, the processor 7 may monitor the key signal index in real time through a microcontroller or an FPGA, and adjust the emission parameter in real time based on the preset adjustment rule.

In some embodiments of the present disclosure, by real-time monitoring of the peak amplitude and the signal-to-noise ratio, and then adjusting the emission parameter of the laser Doppler vibrometer 14, the reliability and sensitivity of laser ultrasonic detection are significantly improved.

In some embodiments of the present disclosure, the detection device for laser spot welding micro-weld spot quality based on laser ultrasound may be applied to high-temperature and extreme environments and the detection of structural members with complex morphology, with fast scanning speed, intuitive and reliable detection results, and simple and easy-to-implement hardware devices.

FIG. 5 is a flowchart illustrating an exemplary detection process of a detection device for laser spot welding micro-weld spot quality based on laser ultrasound according to some embodiments of the present disclosure. As shown in FIG. 5, the process includes the following operations:

In some embodiments, before implementing the detection process of a detection device for laser spot welding micro-weld spot quality based on laser ultrasound, the nanosecond pulsed laser and the laser Doppler vibrometer need to be active, the sample may be placed on the multi-axis displacement platform, and a position and angle of the sample may be adjusted to make the direction current (DC) signal of the Laser Doppler Vibrometer is maximized.

In some embodiments, a plurality of samples with different welding spot characteristics may be used when performing multiple detections.

In S1, a one-dimensional linear shape scanning and a two-dimensional rectangular shape scanning may be performed under a first condition.

In some embodiments, the processor may send a scanning parameter to a scanning galvanometer to control the scanning galvanometer to perform the one-dimensional linear shape scanning and the two-dimensional rectangular shape scanning under the first condition, and the scanning galvanometer may send a scanning result to the processor after the scanning galvanometer has finished the scanning.

In some embodiments, the processor may determine the scanning parameter in multiple ways. For example, the processor may obtain a scanning position and a preset scanning path input by a user, and determine the scanning position and the preset scanning path as the scanning parameter.

In some embodiments, the first condition may include the laser beam and the probe light on the opposite side of the sample.

In some embodiments, the processor may control the scan galvanometer 11 to perform scanning based on the target scanning path under the first condition.

In S2, the two-dimensional rectangular shape scanning may be performed under a second condition.

In some embodiments, after the processor may control the scanning galvanometer to perform the one-dimensional linear shape scanning and the two-dimensional rectangular shape scanning under the first condition, a position of the laser Doppler vibrometer needs to be moved to perform the two-dimensional rectangular shape scanning under the second condition.

In some embodiments, the processor may send the scanning parameter to the scanning galvanometer to control the scanning galvanometer to perform the two-dimensional rectangular shape scanning under the second condition, and the scanning galvanometer may send a scanning result to the processor after the two-dimensional rectangular shape scanning is completed.

In some embodiments, the second condition may include the laser beam and the probe light on the same side of the sample.

In some embodiments, the processor may control the scan galvanometer 11 to perform scanning based on the target scanning path under the second condition.

In S3, a scanning path of the scanning galvanometer may be controlled, positions of a plurality of excitation points and a position of a detection spot may be recorded, an acoustic field of an ultrasonic wave may be visualized, and a result of a visualization process may be obtained.

In some embodiments, the processor may record the positions of the plurality of excitation points and the position of the detection spot based on a preset scanning path, and visualize the acoustic field of the ultrasonic wave to obtain the visualization processing result.

The excitation point is a position on the preset scanning path of the surface of the sample where luminescence occurs due to the energy of the incident laser beam.

The detection spot refers to a spot presented by the probe light on the surface of the sample.

In some embodiments, the processor may visualize the acoustic field of the ultrasonic wave in a variety of ways based on positions of the plurality of excitation points and the position of the detection spot. For example, the processor may visualize the acoustic field of the ultrasonic wave based on a principle of acoustic reciprocity.

For example, the principle of acoustic reciprocity may be expressed by the following equation (a):

$${P}_{A} ( {X}_{Bi} , ti ) = {P}_{Bi} ( {X}_{A} , ti ) , \qquad Equation ( a )$$

ti represents a moment of scanning to an ith excitation point, X_{A} represents a position of the detection spot, P_{A} represents an acoustic field at the position X_{A}, X_{Bi} represents a position of the ith excitation point, and P_{Bi} represents an acoustic field at the position X_{Bi}, and a range of i may include 1-n, and n is a count of excitation points.

In S4, an energy density spectrum of transmission may be determined.

In some embodiments, the processor may determine an energy density spectrum of transmission based on the acoustic field at the positions of the plurality of excitation points by a preset energy equation. For example, the preset energy equation may be represented by the following equation (b):

$$E = {( {P}_{Bi} )}^{2} , \qquad Equation ( b )$$

E represents energy at a sound field P_{Bi}, P_{Bi} denotes the sound field at the position X_{Bi}, and a range of i may include 1-n, n is a count of excitation points.

In some embodiments, the processor may directly determine the welding quality of the laser spot welding based on the visualization processing result. For example, the processor may determine a key signal index based on the visualization processing result, and in response to comparing the key signal index with a standard signal index, obtain a parameter item that is different from the standard signal index, and record the parameter item as a difference item. The processor may calculate a count of 1-difference items, and use a ratio of the count of 1-difference items to a total count of parameter items in the key signal index as the welding quality of the laser spot welding.

More descriptions regarding the key signal index may be found in FIG. 1 and the related descriptions thereof. The standard signal index refers to an ideal key signal index. The standard signal index may be preset by those skilled in the art based on a sample type, etc.

In some embodiments, the difference between the key signal index and the standard signal index may include that a difference between a peak amplitude in the key signal index and a peak amplitude in the standard signal index is greater than a first difference threshold, and a difference between a signal-to-noise ratio in the key signal index and a signal-to-noise ratio in the standard signal index is greater than a second difference threshold. The first difference threshold and the second difference threshold may be preset based on historical experience.

In some embodiments, the difference between the key signal index and the standard signal index may include that an energy of a specific frequency is not within a preset energy range. The preset energy range may be preset based on historical experience.

In some embodiments, the processor may determine the welding quality based on the visualization processing result and the environmental data through a quality prediction model.

The environmental data refers to data related to an environment in which the detection device for laser spot welding micro-weld spot quality based on laser ultrasound is located, such as a temperature, a humidity, an air pressure, etc. The processor may obtain the environmental data through a plurality of sensors (e.g., a temperature sensor, etc.) disposed in the environment.

In some embodiments, the quality prediction model may be a machine learning model, including an interference prediction layer and a quality prediction layer. For example, the interference prediction layer and the quality prediction layer may include any one of a convolutional neural network (CNN) model, a neural network (NN) model, or other custom model structures, or any combination thereof.

In some embodiments, an input of the interference prediction layer may include the visualization processing result and the environmental data, and an output of the interference prediction layer may include an interference factor. An input of the quality prediction layer may include the interference factor and the visualization processing result, and an output of the quality prediction layer may include the welding quality. The interference factors refer to factors that may interfere with the visualization processing result.

In some embodiments, the processor may train the interference prediction layer based on a large number of second training samples with second labels by gradient descent, etc. The second training samples may include a sample visualization processing result and sample environment data, and the second labels of the second training samples may include actual interference factors.

In some embodiments, the second training samples may be obtained based on historical data, and the second labels may be determined based on manual annotation. For example, the processor may use the visualization processing result and the environmental data in a historical detection process as the second training samples. As another example, those skilled in the art may screen the sample environmental data based on a preset factor table to obtain the interference factor corresponding to the second training sample, i.e., the second label.

In some embodiments, the preset factor table may be preset based on experimental data, including a plurality of samples and reference environmental data corresponding to each of the samples. The reference environmental data may include a reference range for each parameter in the environmental data. If a parameter in the sample environmental data is not within the reference range of the same parameter in the reference environmental data, those skilled in the art may determine the parameter as an interference factor. The interference factors may be a name of the parameter and a specific value of the parameter, such as (temperature, 95° C.), etc.

For example, an experimental process may include: performing welding spot quality detection on a plurality of samples of the same type under different environments to obtain a plurality of visualization processing results. Environmental data corresponding to a visualization processing result that satisfies a screening condition may be extracted, a maximum value and a minimum value of each parameter in the obtained environmental data may be determined, and a reference range corresponding to parameters of the maximum value and the minimum value of each parameter is formed so as to obtain the reference environmental data. The maximum value of the parameter may be used as an upper limit of the reference range, and the minimum value of the parameter may be used as a lower limit of the reference range. The screening condition may include that the signal-to-noise ratio of the visualization processing result is less than the signal-to-noise ratio threshold, etc. More descriptions regarding the signal-to-noise ratio threshold may be found in FIG. 5 and the related descriptions thereof.

In some embodiments, the training process of the interference prediction layer may be similar to the training process of the feature extraction model, which may be found in the training process of the feature extraction model in FIG. 5.

In some embodiments, the processor may train the quality prediction layer based on a large number of third training samples with third labels by gradient descent, etc. The third training samples may include a sample visualization processing result and a sample interference factor, and the third label of the third training sample may include an actual welding quality.

In some embodiments, the third training samples may be obtained based on historical data. For example, the processor may use the visualization processing result and the interference factor in the historical detection process as the third training sample.

In some embodiments, the third labels may be determined based on an energy density spectrum corresponding to the sample visualization processing result. For example, the processor may extract a time-frequency feature of the energy density spectrum through short-time Fourier transform or wavelet transform, and perform time or frequency environmental interference compensation of the energy density spectrum based on the sample interference factor and the time-frequency feature, and perform operations S5-S7 on the energy density spectrum after the compensation to obtain the welding quality as the third label (needs to be constructed for specific interference factors, which is described with the interference factor being temperature as an example below).

The time-frequency feature characterizes a change of a signal frequency over time by expanding the energy density spectrum to a time-frequency two-dimensional plane through a time-frequency distribution.

The environmental interference compensation refers to compensating the energy density spectrum in time or frequency according to the interference factor. For example, the interference factor is (temperature, 95° C.), and the processor may substitute 95° C. into a pre-built compensation model corresponding to the temperature to obtain an offset value, and perform the time or frequency compensation of the energy density spectrum based on the offset value and the time-frequency feature. The offset value may include a time offset value or a frequency offset value. The compensation model may include a time compensation model, a frequency compensation model, etc.

In some embodiments, the time compensation model and the frequency compensation model may be pre-constructed based on experimental data by linear regression fitting, or the like. For example, an experimental offset value (e.g., a time delay or a frequency offset) is determined by comparing an energy density spectrum obtained by the experiment with an energy density spectrum calculated theoretically, and the time compensation model or the frequency compensation model is constructed by linear regression fitting based on the experimental offset value and the energy density spectrum obtained by the experiment.

In some embodiments, the training process of the quality prediction layer may be similar to the training process of the feature extraction model, which maybe found in the training process of the feature extraction model in FIG. 5.

In some embodiments, an input of the interference prediction layer may include a temperature field distribution of a welding region. When the input of the interference prediction layer includes the temperature field distribution of the welding region, the second training samples may include a sample temperature field distribution. The sample temperature field distribution may be acquired based on historical data.

The temperature field distribution may be used to characterize a temperature change at different positions and/or time in space. In some embodiments, the temperature field distribution may be acquired by the image sensor.

In some embodiments of the present disclosure, the temperature field distribution of the welding region is collected synchronously while inspecting the quality of the welding spots, such that the interference prediction layer can distinguish different defects (e.g., pores or impurities, etc.) with similar acoustic responses, so as to output more accurate interference factors.

In some embodiments of the present disclosure, the welding quality of the laser spot welding is determined by the quality prediction model, which can process a large volume of complex data based on the self-learning ability of the machine learning model, thereby improving the accuracy and efficiency of determining the welding quality.

In some embodiments, the processor may determine the welding quality of the laser spot welding by performing operations S5-S7.

In S5, a dispersion characteristic curve of a Lamb wave may be generated based on a preset algorithm.

In some embodiments, the processor may generate the dispersion characteristic curve of the Lamb wave based on the preset algorithm. The preset algorithm may include a two-dimensional Fourier transform. For example, the preset algorithm is shown may be represented by the following equation (c):

$$U ( f , k ) = {\int }_{- ∞}^{∞} {\int }_{- ∞}^{∞} u ( ti , {X}_{Bi} ) {e}^{- j ( 2 π f t - {kX}_{Bi} )} {dtdX}_{Bi} , \qquad Equation ( c )$$

j represents an imaginary number, f represents a frequency, k represents a wave number, ti represents a moment of scanning to an ith excitation point, X_{Bi} represents a position of the ith excitation point, a range of i includes 1-n, and n represents a count of excitation point, u(ti, X_{Bi}) represents a value of a spatial domain, and U(f, k) represents a value of a frequency domain. In S6, a speed-frequency curve may be generated.

In some embodiments, the processor may generate a speed-frequency curve based on a frequency differentiation and a wavenumber differentiation. In some embodiments, a horizontal and vertical coordinate of the speed-frequency curve includes multiple forms. For example, a horizontal coordinate of the speed-frequency curve may be frequency and a vertical coordinate may be velocity.

In S7, welding quality of laser spot welding based on the visualization processing result may be determined, the dispersion characteristic curve of a Lamb wave and the speed-frequency curve.

In some embodiments, the processor may determine welding quality of the laser spot weld in a variety of ways based on the visualization processing result, the dispersion characteristic curve of the Lamb wave, and the speed-frequency curve. For example, the processor may select, based on the visualization processing result, the dispersion characteristic curve of the Lamb waves, and the speed-frequency curve, a testing process in a history database that matches the visualization processing result, the dispersion characteristic curve of the Lamb waves, and the speed-frequency curve, and determine welding quality corresponding to the testing process as welding quality of the laser spot welding.

The history database may be preconfigured based on historical data, including multiple testing processes, the visualization processing results of the testing processes, the dispersion characteristic curve of the Lamb wave, and the speed-frequency curve, and the welding quality.

In some embodiments of the present disclosure, the detection process of the detection device for laser spot welding micro-weld spot quality based on laser ultrasound may be convenient and efficient, and the detection process is a completely non-contact laser spot welding micro-weld spot non-destructive detection.

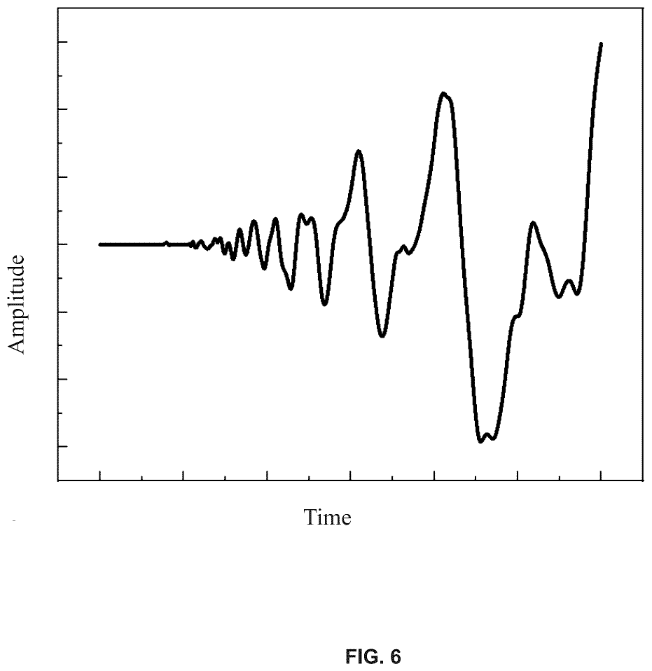

FIG. 6 is a schematic diagram illustrating an exemplary Lamb wave according to some embodiments of the present disclosure.

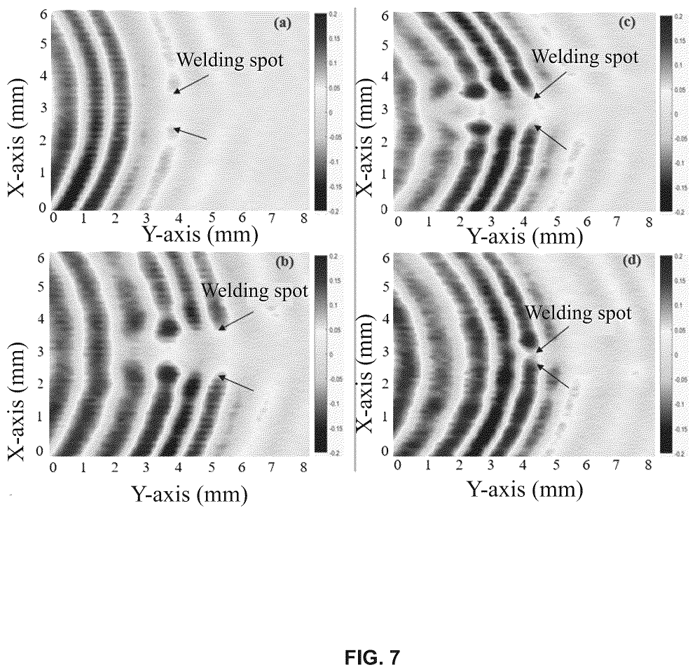

FIG. 7 is a schematic diagram illustrating an exemplary visualization ultrasonic field map according to some embodiments of the present disclosure, wherein (a) and (b) are schematic diagrams illustrating 1.2 mm standard welding at different moments, and (c) and (d) are schematic diagrams illustrating a 0.4 mm standard welding and a 0.4 mm false welding at the same moment.

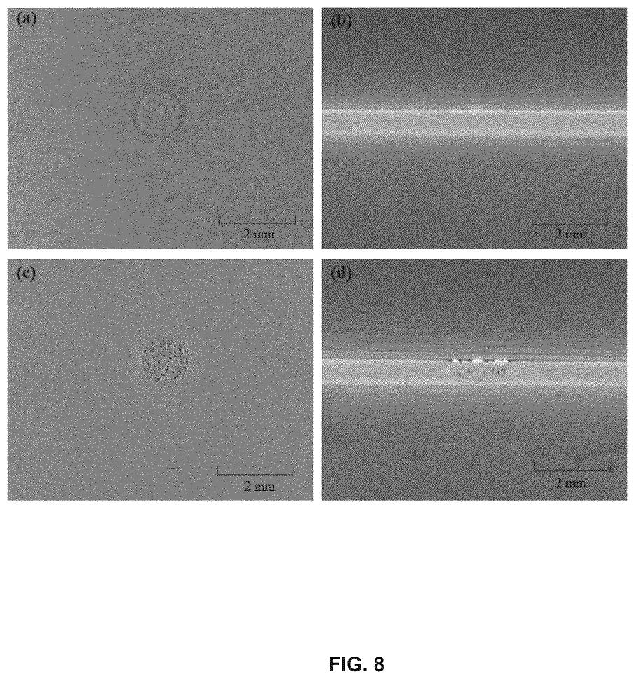

FIG. 8 is a schematic diagram illustrating an exemplary industrial computed tomography (CT) testing result according to some embodiments of the present disclosure; wherein (a) is a schematic diagram illustrating a top view of a 1.2 mm standard welding diagram, (b) is a schematic diagram illustrating a cross-sectional view of a 1.2 mm standard welding diagram, (c) is a schematic diagram illustrating a top view of a 1.2 mm false welding diagram, and (d) is a schematic diagram illustrating a cross-sectional view of a 1.2 mm false welding diagram. The following embodiments may be understood by referring to FIGS. 6, 7, and 8, but the accompanying drawings are only a schematic representation of some of the embodiments and do not constitute a limitation on the embodiments.

In some embodiments, as shown in FIG. 1, the detection device for laser spot welding micro-weld spot quality based on laser ultrasound may include: an ultrasound signal excitation device, an ultrasound signal detection device, and a signal processing unit. The ultrasonic signal excitation device may include a nanosecond pulsed laser 1, and a wavelength of the nanosecond pulsed laser 1 may be 532 nm or 1064 nm, and a pulse width may be 6 to 12 ns, preferably 8 ns. After the nanosecond pulsed laser 11 may emit a pulsed laser passing through the one half-wave plate 2, the polarizing beam splitter 3, and a certain proportion of the laser beam 15 may reach the energy detector 4, and the beam energy of the separated pulsed laser beam 15 through the head 6 of the energy detector. A portion of the laser beam 15 split by the beam splitter mirror 5 may arrive at the photodetector 8 as a trigger signal, and another portion of the laser beam 15 split by the beam splitter mirror 5 may pass through the light reflecting mirror 9, the aperture 10, and arrive at the high-speed scanning galvanometer 11 (with a maximum resonance frequency of 10 KHz) to focus as a point source and excite an ultrasonic wave on the surface of the sample of the multi-axis displacement platform 12 according to the preset scanning path. The ultrasonic signal detection device may include an optical filter 13 with 532 nm high reflectivity and 633 nm high transmittance, and a laser Doppler vibrometer 14 with a 633 nm operating wavelength, the optical filter 13 may be placed at a 45° angle in front of the laser Doppler vibrometer 14. The signal processing unit may include a processor 7. The head 6 of the energy detector, the photodetector 8, and the laser Doppler vibrometer 14 may transmit signals to the processor 7 through data cables, respectively.

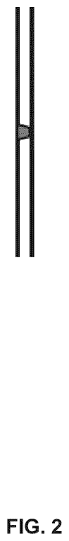

In some embodiments, as shown in FIG. 2, the sample is made by welding two pieces of 304 stainless steel plate with the thickness of 0.2 mm together. The welding spot characteristics may be a standard welding and a false welding with diameters of 1.2 mm and 0.4 mm, respectively, i.e., (a) 1.2 mm standard welding, (b) 1.2 mm false welding, (c) 0.4 mm standard welding, and (d) 0.4 mm false welding.

In some embodiments, the preset scanning path may be a one-dimensional linear shape scanning and a two-dimensional rectangular shape scanning. The laser beam 15 is emitted from nanosecond pulsed laser 1 along the scanning galvanometer 11, and the probe light is emitted along the optical filter 13. In some embodiments, as shown in FIG. 3, the one-dimensional linear shape scanning is performed by the following operations: the laser beam 15 and the probe light 16 are on the opposite side of the sample, the laser beam 15 and the probe light 16 are in the same perpendicular direction, the probe light 16 is located directly below the laser beam 15, and the center of the scanning path of the laser beam 15 is the position of the welding spot. The two-dimensional rectangular shape scanning is performed by the following operations: the laser beam 15 and the probe light 16 are on the opposite side and the same side of the sample, respectively. In some embodiments, as shown in FIG. 4, when the laser beam 15 and the probe light 16 are on the same side of the sample, the probe light 16 is located directly below the rectangular scanning path and the center of the scanning path is at the position of the welding spot; when the laser beam 15 and the probe light 16 are on the opposite side of the sample, the probe light 16 is located at a backside position of the welding spot and the center of the scanning path is the position of the welding spot.

In some embodiments, as shown in FIG. 5, the detection method of the detection device for laser spot welding micro-weld spot quality based on laser ultrasound may include the following operations:

In S1, a nanosecond pulsed laser 1 and a laser Doppler vibrometer 14 may be turned on, a sample to be detected may be placed on a multi-axis displacement platform 12, and a position and angle of the sample may be adjusted to maximize a direct current (DC) signal of the laser Doppler vibrometer 14;

In S2, a scanning parameter may be set, a scanning position and path of the scanning galvanometer 11 may be controlled by a processor 7, and a one-dimensional linear shape scanning and a two-dimensional rectangular shape scanning may be performed, data may be stored in the processor 7, and then a position of the laser Doppler vibrometer 14 may be moved so that the laser beam 15 and the probe light 16 may perform the two-dimensional rectangular shape scanning on the same side of the sample, and data may be stored in the processor 7.

In S3, the scanning path of the scanning galvanometer 11 may be controlled by the processor 7, a position X_{B} of each excitation point and a spot position X_{A} of the probe light 16 may be recorded, and an acoustic field of an ultrasonic wave may be visualized according to a principle of acoustic reciprocity P_{A} (X_{Bi}, ti)=P_{Bi} (X_{A}, ti), wherein ti represents a moment of scanning to the ith excitation point, X_{A} represents a position of a detection spot, P_{A} represents an acoustic field at the position X_{A}, X_{Bi} represents a position of the ith excitation point, and P_{Bi} represents an acoustic field at the position X_{Bi}, and a range of i may include 1-n, and n is a count of excitation points.

In S4, the processor may calculate the energy density spectrum of transmission based on an equation E=(P_{Bi})²;

In S5, As shown in FIG. 6, the processor may draw the dispersion characteristic curve of the Lamb wave according to the two-dimensional Fourier transform, which may be expressed by the following equation (c):

$$U ( f , k ) = {\int }_{- ∞}^{∞} {\int }_{- ∞}^{∞} u ( ti , {X}_{Bi} ) {e}^{- j ( 2 π f t - {kX}_{Bi} )} {dtdX}_{Bi} , \qquad Equation ( c )$$

j represents an imaginary number, f represents a frequency, k represents a wave number, ti represents a moment of scanning to an ith excitation point, X_{Bi} represents a position of the ith excitation point, a range of i includes 1-n, and n represents a count of excitation point, u(ti, X_{Bi}) represents a value of a spatial domain, and U(f, k) represents a value of a frequency domain.

In S6, the processor may draw a speed-frequency curve based on a frequency differentiation and a wavenumber differentiation;

In S7, the processor may determine welding quality of the laser spot welding by analyzing the visualization processing result, the dispersion characteristic curve of the Lamb wave, and the speed-frequency curve.

In some embodiments, as shown in FIG. 7, a 1.2 mm standard welding spot has greater resistance to acoustic wave propagation than 0.4 mm standard welding spot. Additionally, a 0.4 mm standard welding spot has greater resistance to acoustic wave propagation than a 0.4 mm false welding spot.

In some embodiments, as shown in FIG. 8, a 1.2 mm standard welding spot has a dense interior with no air holes, while a 1.2 mm false welding spot has a loose interior with some defects such as air holes.

In addition, certain features, structures, or characteristics of one or more embodiments of the present disclosure may be suitably combined.

Some embodiments use numbers to describe the number of components, attributes, and it should be understood that such numbers used in the description of the embodiments are modified in some examples by the modifiers “approximately” or “generally” is used in some examples. Unless otherwise noted, the terms about,” “approximate,” or “approximately” indicates that a ±20% variation in the stated number is allowed. Correspondingly, in some embodiments, the numerical parameters used in the specification and claims are approximations, which may change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments such values are set to be as precise as possible within a feasible range.

In the event of any inconsistency or conflict between the descriptions, definitions, and/or use of terms in the materials cited in the present disclosure and those described in the present disclosure, the descriptions, definitions, and/or use of terms in the present disclosure shall prevail.

What is claimed is:

1. A detection device for laser spot welding micro-weld spot quality based on laser ultrasound, comprising:
a nanosecond pulsed laser configured to emit a laser, wherein the laser passes through a half-wave plate and a scanning galvanometer to reach a multi-axis displacement platform;
the half-wave plate configured to generate a phase difference of the laser emitted by the nanosecond pulsed laser;
the scanning galvanometer configured to focus the laser as a point source and excite an ultrasonic wave on a surface of a sample according to a preset scanning path, the sample being placed on the multi-axis displacement platform;
the multi-axis displacement platform configured to place and/or move the sample; wherein the multi-axis displacement includes at least a translation axis and a rotation axis to provide the sample with at least two degrees of freedom (DOF) of independent translation and independent rotation;
a laser Doppler vibrometer configured to emit a probe light for detecting the ultrasonic wave;
an image sensor configured to acquire a plurality pieces of image data of the sample in a plurality of attitudes in response to determining that the multi-axis displacement platform translates the sample based on the translation axis or rotates the sample based on the rotation axis, the plurality pieces of image data being used to determine a surface feature of the sample;
an optical filter configured to receive the probe light emitted by laser Doppler vibrometer to adjust an intensity of the probe light, the laser passing through the optical filter to reach the multi-axis displacement platform; wherein a preset angle of the optical filter is set based on a sample feature, and the sample feature includes the surface feature obtained based on the plurality pieces of image data; and
a processor configured to be in communication connection with the image sensor, the optical filter, the nanosecond pulsed laser, the scanning galvanometer, the multi-axis displacement platform, and the laser Doppler vibrometer.

2. The detection device of claim 1, further comprising:
a polarizing beam splitter configured to perform laser beam splitting on the laser passing through the half-wave plate, wherein the laser after performing the laser beam splitting by the polarizing beam splitter enters an energy detector and a beam splitter mirror, and the energy detector is connected with the processor by a head of the energy detector;
the beam splitter mirror configured to perform the laser beam splitting on the laser entering the beam splitter mirror, wherein the laser after performing the laser beam splitting enters a photodetector and a light reflecting mirror, respectively, the photodetector is connected with the processor, the light reflecting mirror is configured to change a direction of the laser; and
an aperture configured for the laser passing through the light reflecting mirror to reach the scanning galvanometer.

3. The detection device of claim 1, wherein the preset scanning path includes at least one of a one-dimensional linear shape scanning, a two-dimensional rectangular shape scanning, and a target scanning path, and the processor is configured to:
determine, based on the plurality pieces of image data, a welding spot set of the sample, and determine one or more welding spots in the welding spot set as one or more first key points;
determine, based on the plurality pieces of image data, one or more abnormal regions on the surface of the sample;
determine one or more welding spots with an abrupt texture change in the one or more abnormal regions as one or more second key points;
and determine, based on the one or more first key points and the one or more second key points; the target scanning path.

4. The detection device of claim 3, wherein the processor is further configured to:
generate a plurality of candidate scanning paths;
for one of the plurality of candidate scanning paths:
determine, based on a first coverage rate of the candidate scanning path to the one or more first key points and a second coverage rate of the candidate scanning path to the one or more second key points, assessment data corresponding to the candidate scanning path; and
determine, based on the assessment data corresponding to the plurality of candidate scanning paths, the target scanning path.

5. The detection device of claim 3, wherein when the preset scanning path is the one-dimensional linear shape scanning, the laser and the probe light are on an opposite side of the sample, and the probe light is emitted by the laser Doppler vibrometer.

6. The detection device of claim 5, wherein when the preset scanning path is the one-dimensional linear shape scanning and the laser and the probe light are on the opposite side of the sample, the laser and the probe light are located in a same perpendicular direction, the probe light is located below the laser, and a center of a scanning path of the laser is a position of a welding spot.

7. The detection device of claim 3, wherein when the preset scanning path is the two-dimensional rectangular shape scanning, the laser and the probe light are on an opposite side or a same side of the sample.

8. The detection device of claim 7, wherein when the preset scanning path is the two-dimensional rectangular shape scanning and the laser and the probe light are on the opposite side of the sample, a position of the probe light is a backside position of a welding spot, and a center of a scanning path of the laser is a position of a welding spot.

9. The detection device of claim 7, wherein when the preset scanning path is the two-dimensional rectangular shape scanning and the laser and the probe light are on the same side of the sample, the probe light is located directly below the preset scanning path, and a center of a scanning path of the laser is a position of a welding spot.

10. The detection device of claim 1, wherein the processor is further configured to:
determine, based on the surface feature of the sample, a wavelength and a pulse width of the nanosecond pulsed laser.

11. The detection device of claim 10, wherein the processor is further configured to:
in response to determining that the scanning galvanometer is configured to excite the ultrasonic wave on the surface of the sample according to the preset scanning path, adjust, based on a visualization processing result obtained by real-time detection and the preset scanning path, the wavelength and the pulse width of the nanosecond pulsed laser.

12. The detection device of claim 1, wherein the processor is further configured to:
in response to determining that the scanning galvanometer is configured to excite the ultrasonic wave on the surface of the sample placed on the multi-axis displacement platform according to the preset scanning path, adjust, based on a visualization processing result obtained by real-time detection, the angle of the optical plate.

13. The detection device of claim 1, wherein the processor is further configured to:
adjust, based on a visualization processing result obtained by real-time detection, an emission parameter of the laser Doppler vibrometer, the emission parameter including at least one of an emission wavelength and an emission pulse width.

14. The detection device of claim 1, wherein a wavelength range of the nanosecond pulsed laser includes 532-1064 nm, and a pulse width range includes 6-12 ns.

15. A detection method for laser spot welding micro-weld spot quality based on laser ultrasound, implemented by a processor, comprising:
performing a one-dimensional linear shape scanning, a two-dimensional rectangular shape scanning, or a scanning based on a target scanning path under a first condition, wherein the first condition includes a laser and a probe light on an opposite side of a sample;
performing the two-dimensional rectangular shape scanning or the scanning based on the target scanning path under a second condition, wherein the second condition includes the laser and the probe light on a same side of the sample;
controlling a scanning path of a scanning galvanometer by the processor, recording positions of a plurality of excitation points and a position of a detection spot, visualizing an acoustic field of an ultrasonic wave, and obtaining a visualization processing result;
determining an energy density spectrum of transmission; and
determining welding quality of laser spot welding based on the visualization processing result.

16. The detection method of claim 15, wherein the determining welding quality of laser spot welding based on the visualization processing result includes:
determining the welding quality of the laser spot welding based on the visualization processing result and environmental result through a quality prediction model, the quality prediction model being a machine learning model; wherein
the quality prediction model includes an interference prediction layer and a quality prediction layer, the interference prediction layer is configured to determine an interference feature based on the visualization processing result and the environmental data, and the quality prediction layer is configured to determine the welding quality based on the interference feature and the visualization processing result.

17. The detection method of claim 16, wherein an input of the interference prediction layer includes a temperature field distribution of a welding region.

18. The detection method of claim 15, wherein the determining welding quality of laser spot welding based on the visualization processing result further includes:
generating a dispersion characteristic curve of a Lamb wave based on a preset algorithm, wherein the preset algorithm includes a two-dimensional Fourier transform, and an expression of the preset algorithm is shown in formula (c):
$$U ( f , k ) = {\int }_{- ∞}^{∞} {\int }_{- ∞}^{∞} u ( ti , {X}_{Bi} ) {e}^{- j ( 2 π f t - {kX}_{Bi} )} {dtdX}_{Bi} \qquad ( c )$$
wherein j represents an imaginary number, f represents a frequency, k represents a wave number, ti represents a moment of scanning to an ith excitation point, X_{Bi} represents a position of the ith excitation point, a range of i includes 1-n, and n represents a count of excitation points, u (ti, X_{Bi}) represents a value of a spatial domain, and U(f, k) represents a value of a frequency domain;
generating a speed-frequency curve; and
determining the welding quality of the laser spot welding based on the visualization processing result, the dispersion characteristic curve of the Lamb wave, and the speed-frequency curve.
